(19) United States
(12) Patent Application Publication
(10) Pub. No.: US 2025/0202251 A1
(43) Pub. Date: Jun. 19, 2025

(54) BATTERY CHARGING CIRCUIT HAVING CURRENT OVERSHOOT PROTECTION

(71) Applicant: Renesas Electronics America Inc., Milpitas, CA (US)

(72) Inventors: Marco SAUTTO, Zurich (CH); Giovanni FIGLIOZZI, Zurich (CH); Sercan IPEK, Zurich (CH); Marcin Kamil AUGUSTYNIAK, Zurich (CH)

(73) Assignee: Renesas Electronics America Inc., Milpitas, CA (US)

(21) Appl. No.: 18/543,063

(22) Filed: Dec. 18, 2023

(51) Int. Cl. H02J 7/00

(52) U.S. Cl. CPC H02J 7/00304; H02J 7/00714; H02J 7/007182; H02J 2207/20

(57) ABSTRACT

A method for operating a battery charging circuit is generally described. The method comprises obtaining a fault condition value and determining that a fault condition is present. The method further comprises setting a freeze signal to a first value based on the determination that the fault condition is present and outputting the freeze signal to a loop control circuit that is configured to inhibit a correction of a battery input current based on the freeze signal. The method further comprises re-obtaining the fault condition value and determining that the fault condition is not present. The method further comprises setting the freeze signal to a second value based on the determination that the fault condition is not present and outputting the freeze signal to the loop control circuit. The loop control circuit is configured to enable a correction of the battery input current based on the freeze signal.

### BACKGROUND

The present disclosure relates in general to semiconductor devices. More specifically, the present disclosure relates to battery charging circuitry.

Battery charging circuits are used to charge batteries by converting power from a power source to a current and voltage suitable for charging a battery. Typically, the current for charging the battery is regulated to be constant in some parts of the charging process while voltage on the regulator itself may vary due to changes on the battery voltage or on the supply voltage. The battery voltage may change due to changes in state of charge or as a consequence of the current flow. The supply voltage may change due to a variety of factors, including internal variables in the system (e.g. different system settings) or external variables (e.g. changed voltage or current availability on the power source) In some cases, a battery charging circuit may comprise current regulation functionality that is configured to regulate the current being provided to the battery. However, such current regulation functionality may have a delayed or slow response time, which may result in a potential current overshoot on the current for charging the battery in a situation where a fault event such as load and/or line transient or under voltage occurs and then clears faster than the response time.

### SUMMARY

In one embodiment, a method for operating a battery charging circuit is generally described. The method comprises obtaining a fault condition value and determining, based on the obtained fault condition value, that a fault condition is present. The method further comprises setting a freeze signal to a first value based on the determination that the fault condition is present and outputting the freeze signal to a loop control circuit. The loop control circuit is configured to inhibit a correction of a battery input current based on the first value of the freeze signal. The method further comprises re-obtaining the fault condition value and determining, based on the re-obtained fault condition value, that the fault condition is not present. The method further comprises setting the freeze signal to a second value based on the determination that the fault condition is not present and outputting the freeze signal to the loop control circuit. The loop control circuit is configured to enable a correction of the battery input current based on the second value of the freeze signal.

In one embodiment, an apparatus is generally described. The apparatus comprises at least one processor. The at least one processor is configured to obtain a fault condition value corresponding to a battery charging circuit and determine, based on the obtained fault condition value, that a fault condition is present. The at least one processor is further configured to set a freeze signal to a first value based on the determination that the fault condition is present and output the freeze signal to a loop control circuit of the battery charging circuit. The loop control circuit is configured to inhibit a correction of a battery input current based on the first value of the freeze signal. The at least one processor is further configured to re-obtain the fault condition value and determine, based on the re-obtained fault condition value, that the fault condition is not present. The at least one processor is further configured to set the freeze signal to a second value based on the determination that the fault condition is not present and output the freeze signal to the loop control circuit. The loop control circuit is configured to enable a correction of the battery input current based on the second value of the freeze signal.

In one embodiment, a semiconductor device is generally described. The semiconductor device comprises a power converter that is configured to convert a power supply signal received from a power supply into a regulated output signal having a regulated DC voltage. The power converter is configured to output a fault condition signal comprising a value corresponding to whether or not a fault event has been detected. The semiconductor device further comprises a main pass device that is configured to receive the regulated output signal as an input and to output a main battery signal. The main battery signal has a voltage and a current and is configured to charge a battery. The semiconductor device further comprises a replica device that is configured to receive the regulated output signal as an input and to output a replica signal having a voltage and current that are scaled relative to the voltage and current of the main battery signal. The semiconductor device further comprises a current generator that is connected to the output of the replica device and configured to adjust the current of the replica signal to generate an adjusted replica signal corresponding to a target current for the main battery signal. The semiconductor device further comprises a loop control circuit that is configured to receive the main battery signal and the adjusted replica signal as inputs and to output a correction signal. The correction signal is configured to adjust at least one parameter of the main pass device to drive the current of the main battery signal being output by the main pass device toward the target current. The semiconductor device further comprises control circuitry that is configured to receive the fault condition signal and to cause the loop control circuit to selectively inhibit or enable the output of the correction signal based on the value of the fault condition signal.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1 is a diagram illustrating an example apparatus that implements a battery charging circuit according to an embodiment.

FIG. 2 is a signal diagram illustrating an example of a short dip fault event scenario in the apparatus of FIG. 1 according to an embodiment.

FIG. 3 is a signal diagram illustrating an example of a long dip fault event scenario in the apparatus of FIG. 1 showing a current overshoot according to an embodiment.

FIG. 4 is a diagram illustrating an example apparatus that implements a battery charging circuit with current overshoot protection according to an embodiment.

FIG. 5 is a diagram illustrating an example overshoot protection circuit of the apparatus of FIG. 4 generating a freeze signal according to an embodiment.

FIG. 6 is a logic table illustrating example logic of the freeze signal of FIG. 5 according to an embodiment.

FIG. 7 is a diagram illustrating an example loop control circuit of the apparatus of FIG. 4 having a switch controlled by the freeze signal of FIGS. 5 and 6 according to an embodiment.

FIG. 8 is a signal diagram illustrating an example of a long dip fault event scenario in the apparatus of FIG. 4 showing no overshoot due to overshoot protection according to an embodiment.

FIG. 9 is a flowchart illustrating an example process implementing current overshoot protection according to an embodiment.

### DETAILED DESCRIPTION

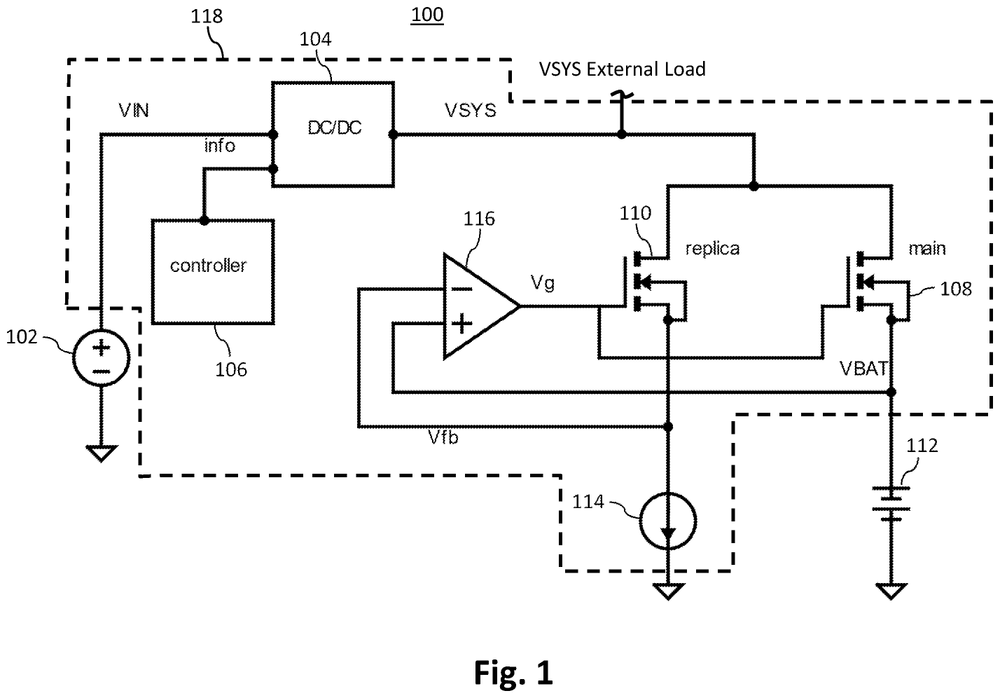

FIG. 1 is a diagram showing an example apparatus 100 for battery charging. Apparatus 100 comprises a power supply 102, a power converter 104, a controller 106, a main pass device 108, a replica device 110, a battery 112, a current generator 114, and a loop control circuit 116.

Apparatus 100 comprises an electronic device, such as, for example, a battery charging device, a desktop computer, a laptop computer, a tablet device, a smartwatch, a cellular phone, a smartphone, a wearable device, an e-cigarette, or any other device that includes battery charging functionality. The charging functionality of apparatus 100 is configured to perform constant current regulation of the current on the battery (IBAT) from the VBAT input that charges battery 112.

Power supply 102 comprises an AC or DC power supply and outputs VIN to power converter 104. For example, power supply 102 may receive power from a wall outlet, wireless power transfer device or any other source of power.

Power converter 104 receives VIN as an input and outputs VSYS. As an example, power converter 104 may comprise an AC/DC converter or a DC/DC regulator that is configured to convert an AC or DC VIN input into a regulated DC output. Power converter 104 comprises safety circuits that are configured to handle the occurrence of over current on VSYS and under voltage on VIN, e.g., by adjusting the current of VSYS accordingly, and may also provide operating and fault data regarding over current, under voltage or other fault information to controller 106 via an info connection, e.g., a wired or wireless communication connection.

Controller 106 comprises, for example, a processor, microcontroller, central processing unit (CPU), field-programmable gate array (FPGA) or any other circuitry that is configured to monitor and manage the charging and other attributes of apparatus 100.

Main pass device 108 comprises a metal-oxide-semiconductor field-effect transistor (MOSFET) or other semiconductor device that is configured to take VSYS as an input and output VBAT. The gate of main pass device 108 is controlled by an input Vg. VBAT is utilized to charge battery 112 and is also provided to loop control circuit 116 as an input.

Replica device 110 comprises a MOSFET or other semiconductor device that is configured to take VSYS as an input and output to Vfb. The gate of replica device 110 is also controlled by input Vg. In some embodiments, replica device 110 may pass through a voltage and current as an output that is scaled down compared to the output of main pass device 108, e.g., 1/1000 of main pass device 108, which may be utilized by loop control circuit 116 to adjust Vg.

Battery 112 comprises a single battery cell, multiple battery cells or one or more battery packs each comprising one or more battery cells. Battery 112 is charged by VBAT. In some embodiments, it may be desirable to maintain the battery current (IBAT) at or as close to a target current as possible.

Current generator 114 is connected to the output of replica device 110 and establishes a target current for it. As an example, current generator 114 may establish a target current for the replica device that corresponds to the target current for the battery, e.g., is scaled proportionately to the ratio of main pass device 108 and replica device 110.

Loop control circuit 116 is configured to provide a closed loop feedback reaction to fluctuations in VSYS, battery current and battery voltage. Loop control circuit 116 is configured to react to changes in the voltage and current of VSYS and VBAT and output Vg as a correction signal that adjusts and controls the gates of both main pass device 108 and replica device 110 to set the ON resistance value Rseries for each device. As an example, if VBAT=3V, VSYS=3.1V and the target IBAT is 1 A, loop control circuit 116 may set Vg to a voltage corresponding to an Rseries of 0.1Ω, correcting the outputs from main pass device 108 and replica device 110 to keep the current constant. Loop control circuit 116 is configured to respond to changes in within a predetermined period of time. As an example, VSYS changes that are shorter in duration than the predetermined period of time may result in a loss of accuracy on the correction and in some cases may result in system instability in the current of VBAT being supplied to battery 112. In one embodiment, main pass device 108 can be a NMOS device or a PMOS device. When main pass device 108 is a NMOS device, higher Vg can lead to higher current and lower Rseries, but when pass device 108 is a PMOS device, the polarities will be inverted. The present disclosure includes examples for main pass device 108 being an NMOS device.

In some embodiments, apparatus 100 comprises an integrated circuit (IC) 118 comprising power converter 104, controller 106, main pass device 108, replica device 110, current generator 114 and loop control circuit 116 that can be operated to facilitate charging battery 112 and powering loads external to IC 118 based on power provided by power supply 102. For example, when power supply 102 is connected to IC 118, power converter 104 can be driven by controller 106 to convert VIN into VSYS, also referred to as the system voltage. VSYS is provided to external loads, e.g., other components of a mobile or other device, and can also be utilized to charge battery 112 via main pass device 108. In other embodiments, the components of apparatus 100 may be part of multiple ICs, separate circuits, or any combination thereof.

The voltage on VSYS is set by power converter 104 based on the characteristics of VIN and based on any loads on VSYS. When an over current event on VSYS or an under-voltage event on VIN is detected by power converter 104, power converter 104 may respond by limiting or reducing the current supplied to VSYS.

Limiting the current of VSYS serves to protect power converter 104 and also handles drops in VIN voltage, e.g., due to increased resistance at power supply 102. If current is limited or reduced on VSYS, the voltage on VSYS also drops or dips. When the current draw on VSYS from the external load is removed or reduced within an acceptable level, or VIN recovers, power converter 104 may return the current/voltage of the VSYS output to an original regulation state, e.g., target voltage/current, or settle into a new regulation state, e.g., a state that is close to the edge of the faulty condition.

Prior to a VSYS change, Vg is stable based on the correspondence between VBAT and Vfb where, for example, VBAT has a current corresponding to the target current set by current generator 114. When the voltage on VSYS changes, e.g., dips, loop control circuit 116 adjusts the voltage on Vg in order to compensate and attempt to maintain constant current regulation at the VBAT output. For example, a change in the voltage on VSYS may impact the current regulation of VBAT on the output of main pass device 108. Because of this, the output of replica device 110 is adjusted by current generator 114 based on the target current and fed into loop control circuit 116 as input Vfb. VBAT is also fed into loop control circuit as an input.

Loop control circuit 116 outputs Vg based on the correspondence between Vfb and VBAT to control the gates of main pass device 108 and replica device 110 and adjust their corresponding Rseries values. The adjusted Rseries value for main pass device 108 serves to regulate and maintain the output current of VBAT at the target current for supplying battery 112.

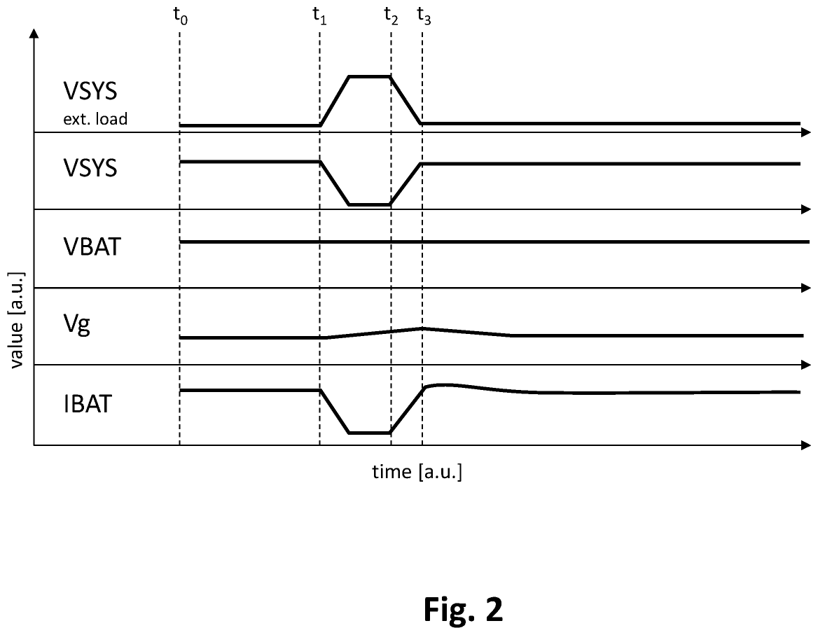

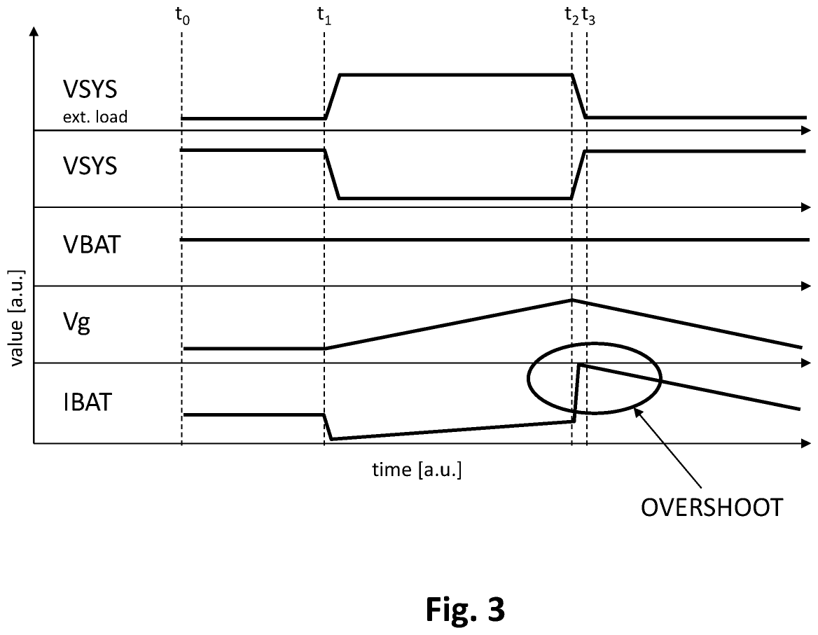

With reference to FIGS. 2 and 3, in some cases, a VSYS change event may occur faster than the response time of loop control circuit 116. Note that in FIGS. 2 and 3, specific values and times have been omitted for brevity and clarity of explanation.

FIG. 2 illustrates an example signal diagram showing a short dip on VSYS, e.g., much shorter than the response time of loop control circuit 116. Initially at time t₀, the external load on VSYS is nominal and VSYS is outputting at a target voltage. VBAT and Vg each have steady voltages while IBAT (the current on the VBAT output) is constant at the target current.

At time t₁, the external load on VSYS increases, causing a corresponding dip in VSYS. As further shown, the charging current on the battery (IBAT) also dips since it is directly proportional to VSYS-VBAT. For example, if the transient VSYS-VBAT becomes half the original value, the IBAT current will also become approximately half the original target current value. At time t₁, Vg also begins to rise in an attempt to correct the current dip on IBAT.

At time t₂, the external load on VSYS is removed and the voltage on VSYS is rapidly pulled up by power converter 104 to the target value by time t₃. Vg continues to rise until time t₃ while IBAT rapidly rises between time t₂ and time t₃ due to the rapid increase in voltage on VSYS. Because Vg is higher than the original steady value, the current on IBAT is also temporarily higher than the target current value, peaking at time t₃ and slowly returning to the target current value as Vg slowly returns to the original steady value. Because the short dip on VSYS is minor and fast in nature, the IBAT current does not increase significantly above the target current value after the external load is removed.

FIG. 3 illustrates an example signal diagram showing a long dip on VSYS, e.g., a dip that is long enough for some response by loop control circuit 116 to occur. Initially at time t₀, the external load on VSYS is nominal and VSYS is outputting at a target voltage. VBAT and Vg each have steady voltages while IBAT (the current on the VBAT output) is constant at the target current.

At time t₁, the external load on VSYS increases, causing a corresponding dip in VSYS. As further shown, the charging current on the battery (IBAT) also dips since it is directly proportional to VSYS-VBAT. For example, if the transient VSYS-VBAT becomes half the original value, the IBAT current will also become approximately half the original target current value. At time t₁, Vg also begins to rise in an attempt to correct the current dip on IBAT, slowly pulling the IBAT value up as time approaches time t₂, e.g., by turning on the main pass device 108. As seen in FIG. 3, the voltage Vg rises substantially relative to the original steady voltage with the current IBAT rising toward the target current.

At time t₂, the external load on VSYS is removed and the voltage on VSYS is rapidly pulled up by power converter 104 to the target value by time t₃. Vg starts decreasing at or after time t₂ while IBAT rapidly rises between time t₂ and time t₃ due to the rapid increase in voltage on VSYS. Because Vg at time t₃ is much higher than the original steady value, the rapid increase of the current on IBAT quickly exceeds the target current in a sudden and uncontrolled IBAT current spike, also referred to as an overshoot.

After time t₃, as Vg continues to decrease, the corresponding IBAT current also decreases until IBAT returns to the target current. Unlike the short dip, the current spike overshoot during a long dip may be significant in nature due to the rise in Vg during the dip and may have the potential to damage battery 112 or other components of apparatus 100.

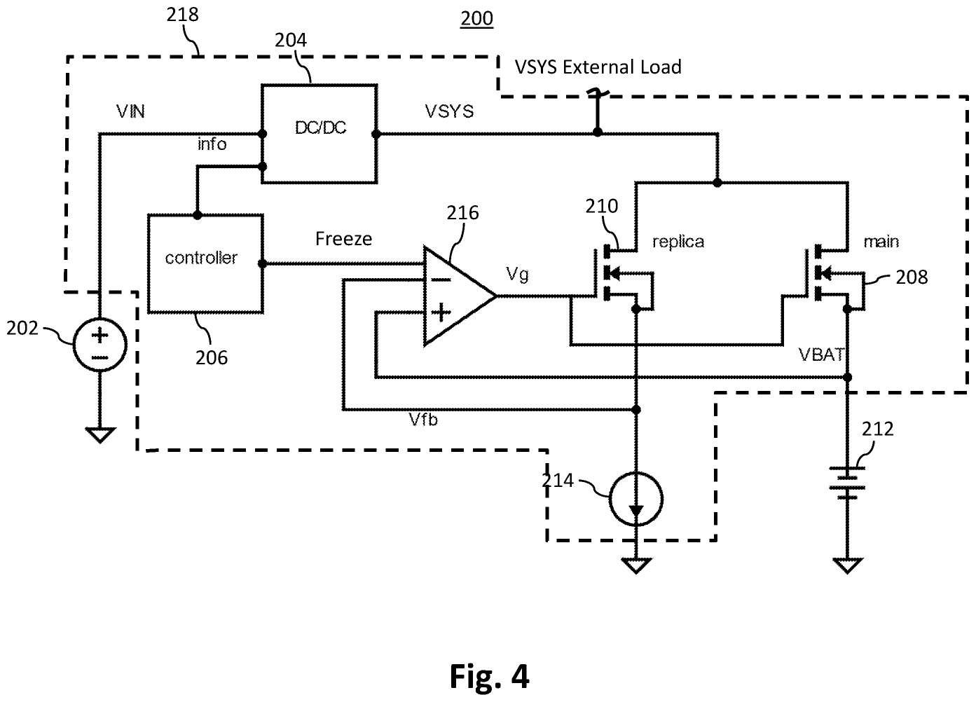

With reference to FIGS. 4-7, an example apparatus 200 according to an embodiment will be described. Apparatus 200 comprises a power supply 202, a power converter 204, a controller 206, a main pass device 208, a replica device 210, a battery 212, a current generator 214, and a loop control circuit 216 each of which may comprise similar functionality to that described above for similarly numbered components of apparatus 100. Some or all of the components of apparatus 200 illustrated in FIG. 4 may also be integrated together in an IC 218, comprise separate circuitry or any combination thereof. As an example, power converter 204, controller 206, main pass device 208, replica device 210, current generator 214, and loop control circuit 216 may be formed as a single IC 218 in some embodiments.

As shown in FIG. 4, apparatus 200 further comprises a freeze signal that is an input to loop control circuit 216. The freeze signal takes as an input one or more fault signals that are generated by power converter 204 such as, e.g., a signal corresponding to an over current event on VSYS, a signal corresponding to an under-voltage event on VIN or any other fault signal. In some embodiments, the fault signals may comprise or have values that correspond to binary values. In some embodiments, the fault signals are provided to controller 206, for example, as shown in FIG. 4.

Controller 206 may comprise functionality to handle fault signals and generate the freeze signal as an output. In an example, the fault signals may comprise analog signals that are converted by controller 206 into binary values. The binary values may then be utilized to generate the freeze signal. Any other conversions or operations may be performed by controller 206 to generate the freeze signal.

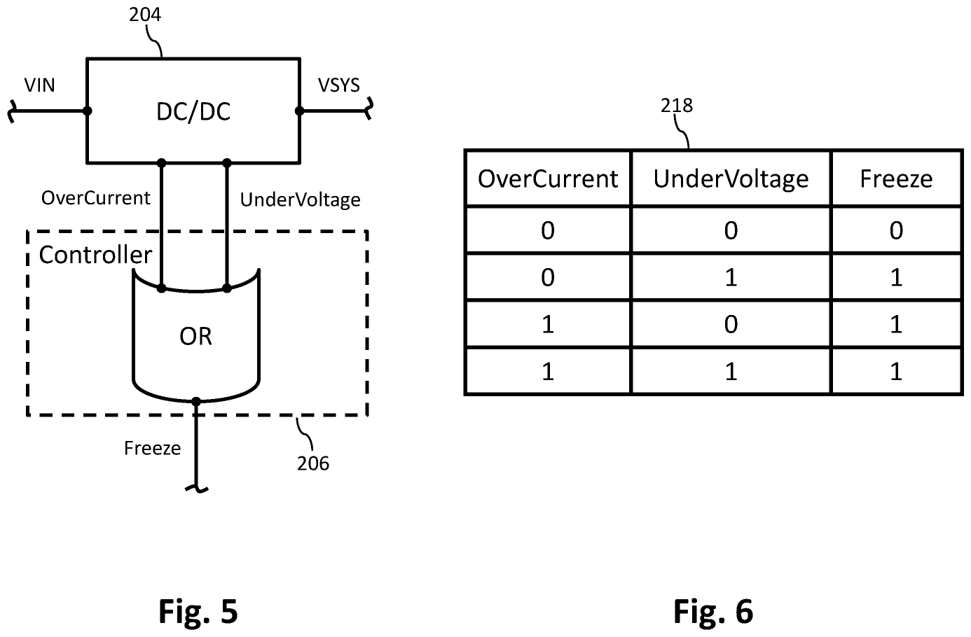

In some embodiments, for example, the fault signals may comprise values corresponding to true or false, e.g., a binary value or its equivalent based on voltage thresholding or other methods. The fault signals may be fed into an OR gate by controller 206 such as that shown in FIG. 5 with a corresponding freeze signal output being generated according to the table shown in FIG. 6. In other embodiments, other logical operations or operators may alternatively be utilized by controller 206 on the fault signals to generate the freeze signal.

In some embodiments, the functionality for generating the freeze signal may be included as part of power converter 204 or may be separate from power converter 204 and controller 206. As an example, circuitry corresponding to an OR gate may be disposed between power converter 204 and loop control circuit 216 to convert the fault signals generated by power converter 204 into the freeze signal, e.g., as shown in FIG. 5. In some embodiments, multiple controllers 206 or other circuitry may alternatively be utilized to generate the freeze signal based on fault signals generated by power converter 204.

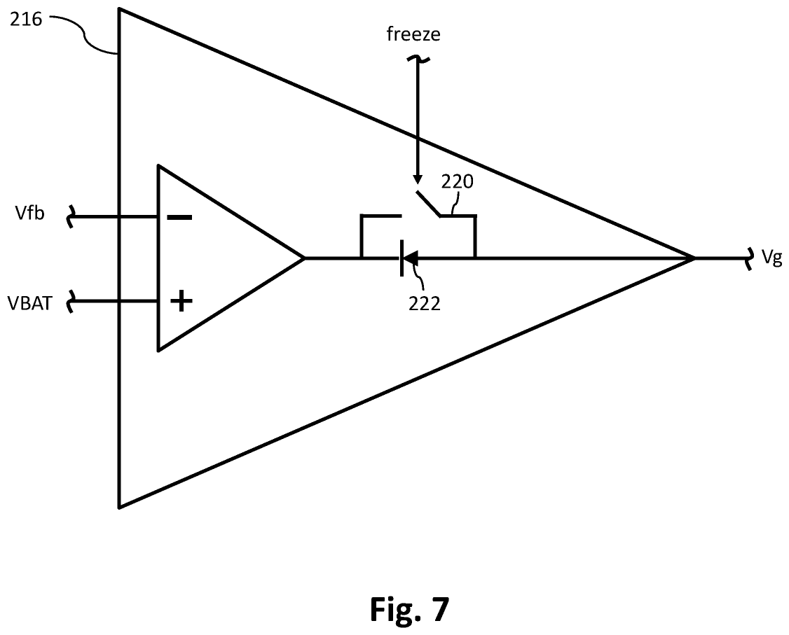

With reference to FIG. 7, the functionality loop control circuit 216 will be described. As seen in FIG. 7, loop control circuit 216 comprises a switch 220 and a device 222 that prevents Vg from increasing, disposed between inputs Vfb and VBAT and output Vg. In one embodiment, loop control circuit 216 can be implemented by a operational transconductance amplifier (OTA) with high output impedance. In one embodiment, device 222 can be a p-n diode, a diode-connected MOS transistor, a superdiode (switch plus comparator), or other types of devices that can function as a diode . . . . The freeze signal is configured to control the operation of switch 220. When switch 220 is open (e.g., turned off), if loop control circuit 216 is an OTA, then the output of amplifier 221 can be allowed to saturate high and the voltage can be stored on the parasitic cap associated to the gate of the pass device 108 (see FIG. 1). When switch 220 is closed (e.g., turned on), the device 222 can be bypassed and if loop control circuit 216 is an OTA, then Vg does not move (or moves negligibly) and the output of amplifier can decrease immediately.

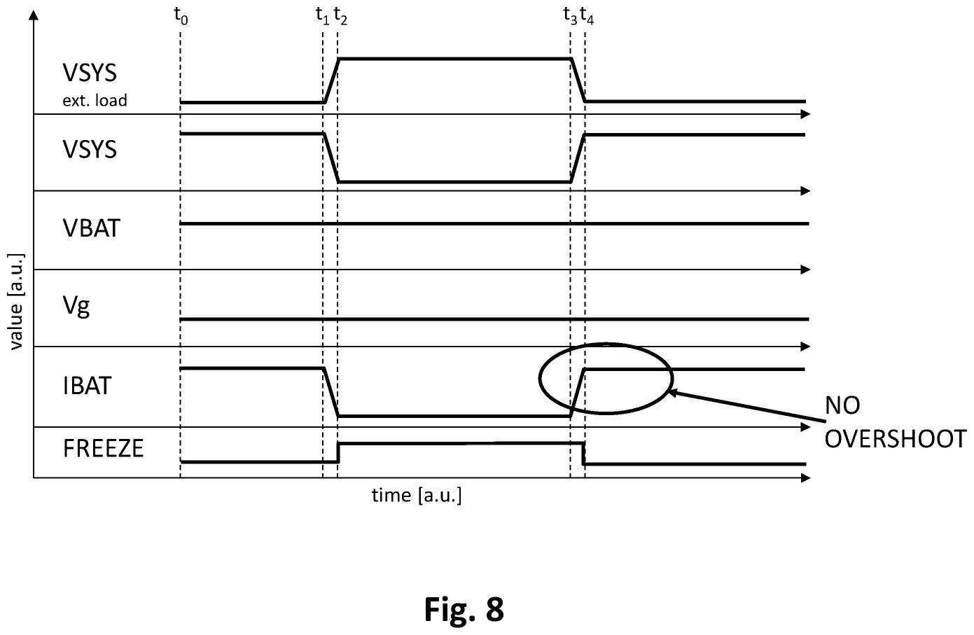

FIG. 8 illustrates an example signal diagram showing a long dip on VSYS on apparatus 200, e.g., a dip that would be long enough for a substantial response by loop control circuit 216 to occur. Initially at time t₀, the external load on VSYS is nominal and VSYS is outputting at a target voltage. VBAT and Vg each have steady voltages while IBAT (the current on the VBAT signal) is constant at the target current. The freeze signal is low and switch 220 is closed.

From time t₁ to time t₂, the external load on VSYS increases, causing a corresponding dip in VSYS. As further shown, the charging current on the battery (IBAT) also dips since it is directly proportional to VSYS-VBAT. For example, if the transient VSYS-VBAT becomes half the original value, the IBAT current will drop to approximately half the original target current value. From time t₁ to time t₂, Vg also begins to rise in an attempt to correct the current dip on IBAT, slowly pulling the IBAT value up as time approaches time t₂, e.g., by turning on the main pass device 108. The freeze signal remains low at time t₁ until power converter 204 detects a fault condition, in this case an over current fault and outputs a true value for the over current fault signal to controller 206 or directly to the OR gate. The freeze signal then becomes true at time t₂.

As seen from times t₂ to t₃, the voltage Vg becomes frozen due to the freeze signal opening or turning off switch 220 and device 222 inhibiting the signal from reaching Vg. IBAT similarly remains below the target current level, and in some cases at a constant value, between times t₂ and t₃.

From time t₃ to t₄, the external load on VSYS is removed and the voltage on VSYS is rapidly pulled up by power converter 104 to the target value. IBAT rapidly rises between time t₃ and time t₄ due to the rise in voltage on VSYS but levels out at about the target current level without significant overshooting due to the freeze of Vg. The freeze signal then becomes false at time t₄ once the over current fault condition clears from power converter 204, i.e., since all fault values are false or low entering the OR gate of FIG. 5. Loop control circuit 216 is now ready to again regulate the current of IBAT during normal operation.

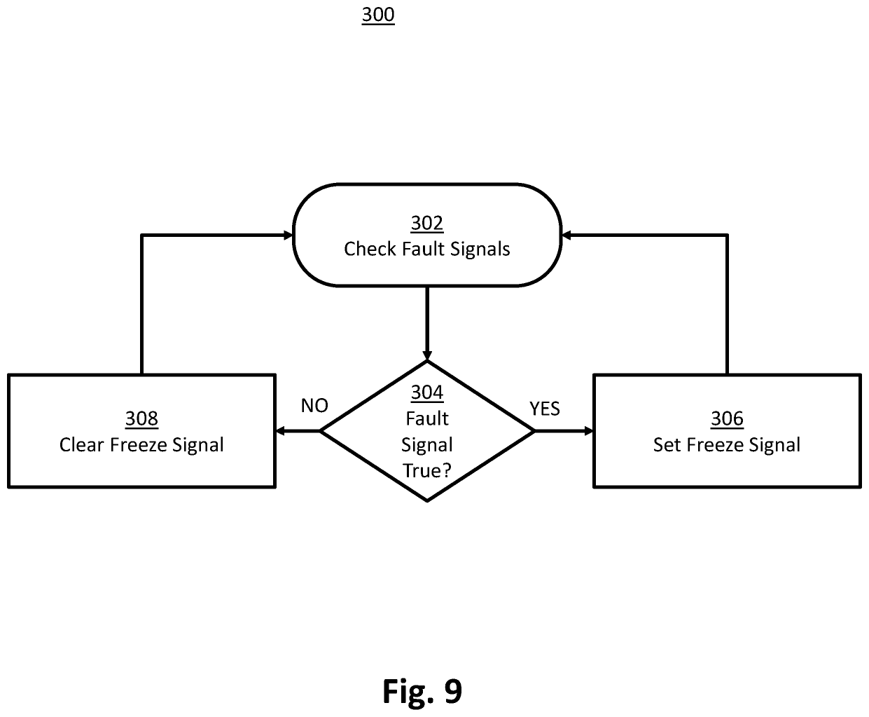

FIG. 9 is a diagram of a flowchart of an example process 300 that implements charging with fault detection and a Vg freeze signal in an embodiment. Process 300 may be implemented using, for example, controller 206 or any other circuitry of apparatus 200. Process 300 may include one or more operations, actions, or functions as illustrated by one or more of blocks 302, 304, 306, and 308. Although illustrated as discrete blocks, various blocks may be divided into additional blocks, combined into fewer blocks, eliminated, performed in different order, or performed in parallel, depending on the desired implementation. Similarly, additional blocks may be added. The description of FIG. 9 may refer to components shown in FIGS. 4-7.

Process 300 begins at block 302. At block 302, controller 206 checks the values of fault signals received from power converter 204. For example, in one scenario power converter 204 may be operating nominally and fault signals such as, e.g., over current and under voltage, may be output at false values. In another scenario, power converter 204 may detect a fault event such as, e.g., an over current on VSYS, an under voltage on VIN or any other fault event and may output a true value for that fault signal. In some embodiments, the fault signals comprise digital signals, e.g., binary values, flags, or other values, which may be read by controller 206. In other embodiments, fault signals may comprise analog signals having values, e.g., voltages, that correspond to a false or true state. Controller 206 is configured to receive the fault signals, whether analog or digital, and determine the fault state for each signal.

At block 304, controller 206 determines whether any of the fault signals received from power converter 204 correspond to a true state. For example, if the fault signal is a digital signal, the digital value may correspond to the true or false state, e.g., a binary 0 or 1 or any other value. In another example, if the fault signal is analog, a value of the analog signal may correspond to a true state, e.g., a voltage above or below a predetermined threshold value or set to a particular voltage value or range. Any other mechanism for conveying a fault signal from power converter 204 to controller 206 may also or alternatively be utilized. If any fault signal is true, the process proceeds to block 306. If all fault signals are false, the process proceeds to block 308.

At block 306, if any fault signal is true, controller 206 sets the freeze signal to true or open (e.g., turn off). For example, the freeze signal may have a value that causes switch 220 to “open” when true, inhibiting the output of Vg from loop control circuit 216 together with device 222. Device 222 will allow the signal Vg to go down if the current measured by the replica is higher than the target charging current. The process then returns to block 302 for further fault checking.

At block 308, if no fault signal is true, controller 206 sets the freeze signal to false or closed (e.g., turn on). For example, the freeze signal may have a value that causes switch 220 to “close” when false, allowing the output of Vg from loop control circuit 216 to adjust the Rseries of main pass device 208 and replica device 210 for regulating IBAT to the target current. The process then returns to block 302 for further fault checking.

While process 300 is described with respect to controller 206, any other circuitry or component of apparatus 200 may alternatively perform process 300. For example, in some embodiments power converter 204 may comprise functionality to both generate fault signals and output the freeze signal directly to loop control circuit 216. In other embodiments, a circuit separate from power converter 204 and controller 206 may perform process 300. For example, separate circuitry may be disposed between power converter 204 and loop control circuit 216 for determining whether or not to set switch 220 to the open (turned off) or closed (turned on) state. An example of such circuitry is illustrated in FIG. 5 where controller 206 is shown as optional. In some embodiments, such separate circuitry may also comprise an analog-digital converter or other functionality necessary to convert any fault signals into signals usable to determine whether fault conditions are true or false and to output a corresponding freeze signal that is usable by switch 220 of loop control circuit 216.

The apparatus and processes described herein provide a mechanism to inhibit substantial overshoot of IBAT current due to Vg rise during charging operations when a fault condition such as, e.g., an over current on VSYS, an under voltage on VIN or another fault, is detected by power converter 204 and the fault condition clears faster than the response time of the Vg output of loop control circuit 216.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be implemented substantially concurrently, or the blocks may sometimes be implemented in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The disclosed embodiments of the present invention have been presented for purposes of illustration and description but are not intended to be exhaustive or limited to the invention in the forms disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for operating a battery charging circuit, the method comprising:
obtaining a fault condition value;
determining, based on the obtained fault condition value, that a fault condition is present;
setting a freeze signal to a first value based on the determination that the fault condition is present;
outputting the freeze signal to a loop control circuit, the loop control circuit being configured to inhibit a correction of a battery input current based on the first value of the freeze signal;
re-obtaining the fault condition value;
determining, based on the re-obtained fault condition value, that the fault condition is not present;
setting the freeze signal to a second value based on the determination that the fault condition is not present; and
outputting the freeze signal to the loop control circuit, the loop control circuit being configured to enable a correction of the battery input current based on the second value of the freeze signal.

2. The method of claim 1, wherein the fault condition comprises at least one of an over current event and an under voltage event.

3. The method of claim 2, wherein determining, based on the obtained fault condition value, that the fault condition is present comprises determining that at least one of the over current event and the under voltage event is present.

4. The method of claim 3, wherein determining, based on the re-obtained fault condition value, that the fault condition is present comprises determining that both the over current event and under voltage event are not present.

5. The method of claim 1, wherein the method is performed by a controller of the battery charging circuit.

6. The method of claim 1, wherein the fault condition value is obtained from a power converter that is configured to convert an input voltage from a power supply into a regulated DC voltage.

7. The method of claim 1, wherein the loop control circuit comprises a switch and a device configured to inhibit a voltage output of the loop control circuit, the switch being configured to bypass the device when turned on, the loop control circuit being configured to:
inhibit the correction of the battery input current based at least in part on the first value of the freeze signal by turning off the switch; and
enable the correction of the battery input current based at least in part on the second value of the freeze signal by turning on the switch.

8. An apparatus comprising at least one processor, the at least one processor being configured to:
obtain a fault condition value corresponding to a battery charging circuit;
determine, based on the obtained fault condition value, that a fault condition is present;
set a freeze signal to a first value based on the determination that the fault condition is present;
output the freeze signal to a loop control circuit of the battery charging circuit, the loop control circuit being configured to inhibit a correction of a battery input current based on the first value of the freeze signal;
re-obtain the fault condition value;
determine, based on the re-obtained fault condition value, that the fault condition is not present;
set the freeze signal to a second value based on the determination that the fault condition is not present; and
output the freeze signal to the loop control circuit, the loop control circuit being configured to enable a correction of the battery input current based on the second value of the freeze signal.

9. The apparatus of claim 8, wherein the fault condition comprises at least one of an over current event and an under voltage event.

10. The apparatus of claim 9, wherein the at least one processor being configured to determine, based on the obtained fault condition value, that the fault condition is present, comprises the at least one processor being configured to determine that at least one of the over current event and the under voltage event is present.

11. The apparatus of claim 10, wherein the at least one processor being configured to determine, based on the re-obtained fault condition value, that the fault condition is present comprises the at least one processor being configured to determine that both the over current event and under voltage event are not present.

12. The apparatus of claim 8, wherein the at least one processor comprises a controller of the battery charging circuit.

13. The apparatus of claim 8, wherein the at least one processor is configured to obtain the fault condition value from a power converter of the charging circuit, the power converter being configured to convert an input voltage from a power supply into a regulated DC voltage.

14. The apparatus of claim 8, wherein the loop control circuit comprises a switch and a device configured to inhibit a voltage output of the loop control circuit, the switch being configured to bypass the device when turned on, the loop control circuit being configured to:
inhibit the correction of the battery input current based at least in part on the first value of the freeze signal by turning off the switch; and
enable the correction of the battery input current based at least in part on the second value of the freeze signal by turning on the switch.

15. A semiconductor device comprising:
a power converter that is configured to convert a power supply signal received from a power supply into a regulated output signal having a regulated DC voltage, the power converter being configured to output a fault condition signal comprising a value corresponding to whether or not a fault event has been detected;
a main pass device that is configured to receive the regulated output signal as an input and to output a main battery signal, the main battery signal having a voltage and a current and being configured to charge a battery;
a replica device that is configured to receive the regulated output signal as an input and to output a replica signal having a voltage and current that are scaled relative to the voltage and current of the main battery signal;
a current generator that is connected to the output of the replica device and configured to adjust the current of the replica signal to generate an adjusted replica signal corresponding to a target current for the main battery signal;
a loop control circuit that is configured to receive the main battery signal and the adjusted replica signal as inputs and to output a correction signal, the correction signal being configured to adjust at least one parameter the main pass device to drive the current of the main battery signal being output by the main pass device toward the target current; and
control circuitry that is configured to receive the fault condition signal and to cause the loop control circuit to selectively inhibit or enable the output of the correction signal based on the value of the fault condition signal.

16. The semiconductor device of claim 15, wherein the control circuitry comprises a controller of a battery charging circuit.

17. The semiconductor device of claim 15, wherein the loop control circuit comprises a switch and a device configured to inhibit the output of the correction signal, the switch being configured to bypass the device when closed, the control circuitry being configured to cause the loop control circuit to turn off or turn on the switch based on the value of the fault condition signal.

18. The semiconductor device of claim 17, wherein:
the control circuitry is configured to:
determine whether or not a fault event has been detected based on the value of the fault condition signal;
set a freeze signal to a first value based on a determination that a fault event has been detected;
set the freeze signal to a second value based on a determination that no fault event has been detected; and
provide the freeze signal to the loop control circuit;
the loop control circuit is configured to:
open the switch to inhibit the output of the correction signal based on the freeze signal having the first value; and
close the switch to enable the output of the correction signal based on the freeze signal having the second value.

19. The semiconductor device of claim 15, wherein the fault condition signal comprises a first fault condition signal and a second fault condition signal, the first fault condition signal corresponding to an under voltage event on the power supply signal and the second fault condition signal corresponding to an over current event on the regulated output signal, the control circuitry being configured to receive the first and second fault condition signals and to cause the loop control circuit to selectively inhibit or enable the output of the correction signal based on the values of the first and second fault condition signals.

20. The semiconductor device of claim 19, wherein the control circuitry is configured to cause the loop control circuit to inhibit the output of the correction signal based on a determination that the value of either of the first and second fault condition signals corresponds to a fault event being present and to enable the output of the correction signal based on a determination that the values of both of the first and second fault condition signals correspond to a fault event not being present.
